(19) United States
(12) Patent Application Publication
(10) Pub. No.: US 2017/0237816 A1
(43) Pub. Date: Aug. 17, 2017

(54) Method and electronic device for identifying device

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Yingjie Li, Tianjin (CN); Shuilong Yu, Tianjin (CN); Guanghui REN, Tianjin (CN); Jieren Lin, Tianjin (CN)

(21) Appl. No.: 15/246,566

(22) Filed: Aug. 25, 2016

Related U.S. Application Data
(63) Continuation of application No. PCT/CN2016/089465, filed on Jul. 8, 2016.

(30) Foreign Application Priority Data
Dec. 10, 2015 (CN) 201510917168.3

(51) Int. Cl. H04L 29/08

(52) U.S. Cl. CPC H04L 67/16; H04L 67/06

(57) ABSTRACT

Disclosed are a method and an electronic device for identifying a device. The method mainly includes: when starting an application program, obtaining a target file and a screen size of a device, wherein the target file is configured to record a wired Media Access Control (MAC) address of the device; and determining a device type of the device according to the target file and the screen size.

### CROSS REFERENCE TO RELATED APPLICATIONS

This application is a continuation of International Application No. PCT/CN2016/089465, filed on Jul. 8, 2016, which is based upon and claims priority to Chinese Patent Application No. 201510917168.3, filed on Dec. 10, 2015, the entire contents of all of which are incorporated herein by reference.

### TECHNICAL FIELD

The present disclosure relates to communication technologies, and more particularly, to a method and an electronic device for identifying a device.

### BACKGROUND

With development of the Android system, devices having different functionalities (for example, mobile phones and TVs and the like) which support the Android system have become more and more integrated into people's lives.

In actual applications, different devices have different features, and the same application may need to perform different processes on different devices. For example, mobile phones are mobile devices and generally not charged continuously, and thus power consumption of mobile phones should be minimized; TVs are not mobile devices and can be charged continuously, and thus minimization of power consumption is not necessary. Thus, for power-saving purposes, the workloads of mobile phones need to be reduced. For example, an application server can send heartbeat packets (which are used for testing whether a mobile phone is online) to a mobile phone at frequency lower than the frequency at which the heartbeat packets (which are used for testing whether a TV is online) are sent to a TV. Thus, during usage of a certain application, the application client or the application server may firstly identify the devices and then perform processes corresponding to the devices.

In prior arts, devices which support the Android system can be identified by the following approach. Build information of a device is obtained, and the type of the device is determined according to contents of the Build information. The Build information includes basic information which is added by the manufacturer before the device is shipped. For example, the basic information can include the name of the manufacturer of the device, the model of the device and the type of the device, and the like. When the basic information includes the device type, it is possible to identify whether the device is a mobile phone or other device. However, during the realization of the present disclosure, inventors have found that the prior arts at least have the following problem. If the basic information does not include the device type, it is not possible to accurately identify the device type of the device. Thus, how to accurately determine the device type of a device which supports the Android system and to perform corresponding processes on the device become a big problem.

### SUMMARY

The present disclosure provides a method and an electronic device for identifying a device in order to solve the problem in prior arts that it is not possible to accurately identify the device type of a device when the Build information does not include the device type.

In a first aspect, embodiments of the present disclosure provide a method for identifying a device, applied to a terminal, including:

obtaining a target file and a screen size of a device, when starting an application program, wherein the target file is configured to record a wired Media Access Control (MAC) address of the device; and

determining a device type of the device according to the target file and the screen size.

In a second aspect, embodiments of the present disclosure provide a non-transitory computer-readable storage medium storing executable instructions, wherein the executable instructions are configured to perform any methods for identifying a device mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for identifying a device mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for identifying a device in accordance with some embodiments.

FIG. 2 is a block diagram of an apparatus for identifying a device in accordance with some embodiments.

FIG. 3 is a block diagram of another apparatus for identifying a device in accordance with some embodiments.

FIG. 4 is a block diagram of an electronic device which is configured to perform the methods for identifying a device in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

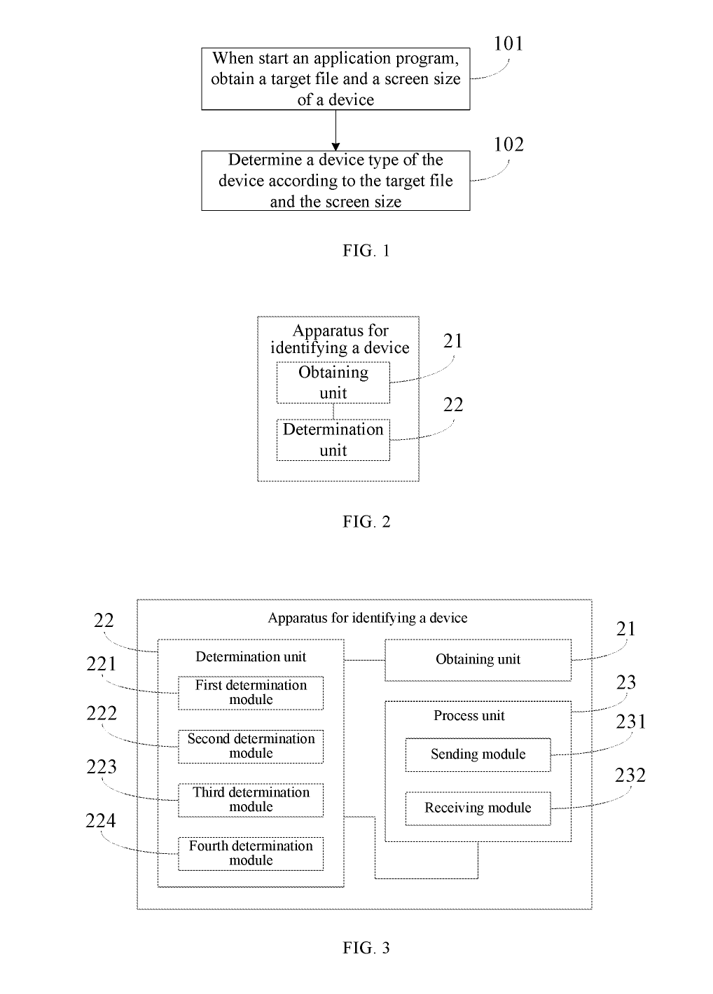

Embodiments of the present disclosure provide a method for identifying a device. As shown in FIG. 1, the method can include the following steps.

In 101, when an application program is started, a target file and a screen size of a device are obtained.

The target file is configured to record a wired Media Access Control (MAC) address of the device. In practical applications, some devices only have a wired network card, some devices only have a wireless network card, and some devices may have the both. Each network card has a unique MAC address, that is, a wired network card can have a wired MAC address and a wireless network card can have a wireless MAC address. Since the MAC address(es) of the device is(are) the same as the MAC address(es) of the network card(s), some devices may only have a wired MAC address, some devices may only have a wireless MAC address, and some devices may have both wireless and wired MAC addresses. For example, a mobile phone usually only has a wireless MAC address, a smart TV only has a wired MAC address, and a table computer has both wired and wireless MAC addresses.

In addition, devices of different types can have different screen sizes. For example, the screen size of a mobile phone is usually around 5 inches (the length of one of the diagonal lines of the screen), the screen of a smart TV is usually around 50 inches, and the screen size of a tablet computer is usually around 9 inches.

It should be noted that, in practical applications, the obtained screen size may refer to the length of one of the diagonal lines of the screen, or may refer to the length and width of the screen.

In addition, due to different requirements of devices, after starting of an application program, the application firstly determines the device type of a device, and then employs a corresponding scheme to meet the requirements of the device of the type.

In 102, a device type of the device is determined according to the target file and the screen size.

Among devices of different types in which the same application is installed, it is possible that at least two types of devices have a wired MAC address, or it is possible that at least two types of device do not have a wired MAC address, or it is possible that at least two types of devices have similar screen sizes. Thus, in most cases, the device type of a device cannot be determined only based on either the wired MAC address in the target file or the screen size, and the device type of a device can be determined only if the two are combined. For example, if it is determined that a device does not have a wired MAC address, the device may be a mobile phone or a tablet computer, and thus the screen size of the device needs to be further checked to make the determination. For example, if the screen size of the device is 4.5 inches, it can be determined that the device is a mobile phone rather than a tablet computer.

It should be noted that the devices in embodiments of the present disclosure mainly refer to devices which support the Android system, and may also refer to devices which support other systems, and embodiments of the present disclosure do not impose specific limitations on this.

In the method for identifying a device provided by embodiments of the present disclosure, when an application program is started, a target file and a screen size of a device are obtained, wherein the target file is configured to record a wired MAC address of the device. And, a device type of the device is directly determined according to the target file and the screen size. Thus, even though the Build information does not include the device type, it is possible to accurately determine the device type of the device and thereby the accuracy for identifying device type is increased.

Further, the determining of the device type of the device according to the target file and the screen size in the step 102 can be specifically implemented as:

if the target file includes the wired MAC address and the screen size is zero, it is determined that the device is a set top box; if the target file includes the wired MAC address and the screen size meets a first size range, it is determined that the device is a smart TV; if the target file does not include the wired MAC address and the screen size meets a second size range, it is determined that the device is a mobile phone; and if the target file does not include the wired MAC address and the screen size meets a third size range, it is determined that the device is a tablet computer.

For example, among four types of devices, i.e., a set top box, a smart TV, a mobile phone and a tablet computer, the set top box and the smart TV each have a wired MAC address, and the mobile phone and the tablet computer do not have a wired MAC address; the screen size of a set top box is zero, the range of the screen size of a smart TV is about 15 to 70 inches (the first size range), the range of the screen size of a mobile phone is about 3 to 7 inches (the second size range), and the range of the screen of a table computer is about 8 to 15 inches (the third size range). It can be seen that if the target file includes the wired MAC address and the screen size is zero, it can be determined that the device is a set top box; if the target file includes the wired MAC address and the screen size falls within the range of 15 to 70 inches, it can be determined that the device is a smart TV; if the target file does not include the wired MAC address and the screen size falls within the range of 3 to 7 inches, it can be determined that the device is a mobile phone; and if the target file does not include the wired MAC address and the screen size falls within the range of 8 to 15 inches, it can be determined that the device is a tablet computer.

It should be noted that the target file is only used to record the wired MAC address and no other contents are recorded, and thus when whether the target file includes a wired MAC address is determined, whether the wired MAC address is contained can be determined directly according to whether the target file is empty. That is, if the target file is empty, it can be determined that the target file does not include a wired MAC address; if the target file is not empty, it can be determined that the target file includes the wired MAC address.

In addition, generally speaking, different devices may store their wired MAC addresses in the same positions (for example, they may store the wired MAC addresses in the address file in/sys/class/net/eth0), and thus when the target file is obtained, the target file can be directly searched according to a preset path. In practical applications, some interfaces dedicated to obtaining the screen size are available, and thus these particular interfaces can be used to obtain the screen size.

Further, as mentioned above, different devices may have different requirements, and thus after the device type of the device is determined, processes can be performed on the device according to a preset process scheme corresponding to the device type. The processes on different devices will be described with the following two scenarios as examples.

In a first scenario, for example, a mobile device (for example, a mobile phone) needs to minimize power consumption, and a device which is not mobile (for example, a smart TV) does not need to minimize power consumption.

Specifically, after the device types of the devices are determined, the device types are sent to an application server; after obtaining the device types of the devices, the application server can send heartbeat packets to the devices in which the application is installed at frequency corresponding to the device types. As such, whether the devices are online can be tested.

Because the mobile device needs to minimize the power consumption, the preset frequency corresponding to the mobile device can be lower than the frequency corresponding to the device which is not mobile. In this way, the frequency for the mobile device to receive the heartbeat packets and the frequency for the mobile device to send response packets are lowered, thereby reducing the power consumption.

For example, the frequency corresponding to the mobile phone is to send or receive packets every five minutes, the frequency corresponding to the smart TV is to send or receive packets every one second. That is, the application server sends the heartbeat packets to the mobile phone every five minutes, and sends the heartbeat packets to the smart TV every one second.

In a second scenario, for example, the current application has a video calling function, and during the video calling, a smart TV may need more powerful sound amplification function than a mobile phone.

Specifically, after the device types of the devices are determined, the sound amplification manners corresponding to the device types can be obtained and performed, so as to realize corresponding sound amplification effects.

Further, embodiments of the present disclosure provide an apparatus for identifying a device to implement the above methods. As shown in FIG. 2, the apparatus can include an obtaining unit 21 and a determination unit 22.

The obtaining unit 21 is configured to, when an application program is started, obtain a target file and a screen size of a device, wherein the target file is configured to record a wired MAC address of the device.

The target file obtained by the obtaining unit 21 is configured to record a MAC address of the device. In practical applications, some devices only have a wired network card, some devices only have a wireless network card, and some devices may have the both. Each network card has a unique MAC address, that is, a wired network card can have a wired MAC address and a wireless network card can have a wireless MAC address. Since the MAC address(es) of the device is(are) the same as the MAC address(es) of the network card(s), some devices may only have a wired MAC address, some devices may only have a wireless MAC address, and some devices may have both wireless and wired MAC addresses. For example, a mobile phone usually only has a wireless MAC address, a smart TV only has a wired MAC address, and a table computer has both wired and wireless MAC addresses.

In addition, devices of different types can have different screen sizes. For example, the screen size of a mobile phone is usually around 5 inches (the length of one of the diagonal lines of the screen), the screen of a smart TV is usually around 50 inches, and the screen size of a tablet computer is usually around 9 inches.

The determination unit 22 is configured to determine a device type of the device according to the target file and the screen size obtained by the obtaining unit 21.

Among devices of different types in which the same application is installed, it is possible that at least two types of devices have a wired MAC address, or it is possible that at least two types of device do not have a wired MAC address, or it is possible that at least two types of devices have similar screen sizes. Thus, in most cases, the determination unit 22 cannot determine the device type of a device only based on either the wired MAC address in the target file or the screen size, and the device type of a device can be determined only if the two are combined.

In the apparatus for identifying a device provided by embodiments of the present disclosure, when an application program is started, a target file and a screen size of a device are obtained, wherein the target file is configured to record a wired MAC address of the device. And, a device type of the device is directly determined according to the target file and the screen size. Thus, even though the Build information does not include the device type, it is possible to accurately determine the device type of the device and thereby the accuracy for identifying device type is increased.

Further, as shown in FIG. 3, the determination unit 22 can include a first determination module 221, a second determination module 222, a third determination module 223 and a fourth determination module 224.

The first determination module 221 is configured to, if the target file includes the wired MAC address and the screen size is zero, determine that the device is a set top box.

The second determination module 222 is configured to, if the target file includes the wired MAC address and the screen size meets a first size range, determine that the device is a smart TV.

The third determination module 223 is configured to, if the target file does not include the wired MAC address and the screen size meets a second size range, determine that the device is a mobile phone.

The fourth determination module 224 is configured to, if the target file does not include the wired MAC address and the screen size meets a third size range, determine that the device is a tablet computer.

It should be noted that generally speaking, the target file is only used to record the wired MAC address and no other contents are recorded, and thus when whether the target file includes a wired MAC address is determined, whether the wired MAC address is contained can be determined directly according to whether the target file is empty. That is, if the target file is empty, it can be determined that the target file does not include a wired MAC address; if the target file is not empty, it can be determined that the target file includes the wired MAC address.

Further, the obtaining unit 21 is configured to obtain the target file along a preset path, and obtain the screen size by a particular interface.

Further, as shown in FIG. 3, the device can further include a process unit 23.

The process unit 23 is configured to perform processes on the device according to a preset process scheme corresponding to the device type determined by the determination unit 22.

Further, as shown in FIG. 3, the process unit 23 can include a sending module 231 and a receiving unit 232.

The sending module 231 is configured to send the device type to an application server.

The receiving module 232 is configured to receive heartbeat packets which are sent by the application server at a frequency corresponding to the device type.

Because a mobile device needs to minimize the power consumption, the preset frequency corresponding to the mobile device can be lower than the frequency corresponding to a device which is not mobile. In this way, the frequency for the receiving module 232 in the mobile device to receive the heartbeat packets and to send response packets are lowered, thereby reducing the power consumption.

Further, the device can be a device which supports the Android system.

The embodiments of the apparatus correspond to the embodiments of the methods, and for the purposes of convenience in reading, details regarding the modules or units in the apparatus are not repeated here. However, it should be noted that the apparatus provided by embodiments of the present disclosure can implement all contents described in the above embodiments of methods.

The above apparatus for identifying a device can include a memory and a processor, and the above obtaining unit, the determination unit and the process unit can be stored in the memory as program units. By execution of the program units stored in the memory by the processor, corresponding functions can be realized.

Further, an embodiment of the present disclosure further provides a non-transitory computer-readable storage medium storing executable instructions, which can be executed by an electronic device to perform any methods for identifying a device mentioned by embodiments of the present disclosure.

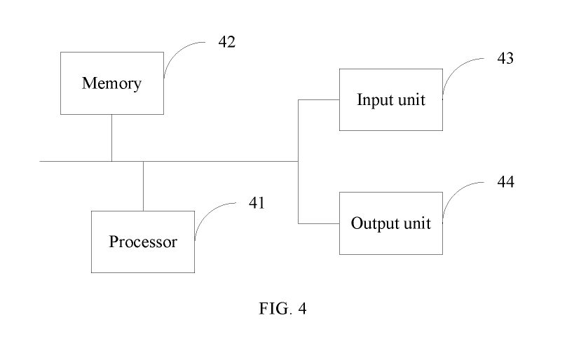

FIG. 4 is a block diagram of an electronic device which is configured to perform the methods for identifying a device according to an embodiment of the present disclosure. As shown in FIG. 4, the device includes:

one or more processors 41 and memory 42. A processor 41 is showed in FIG. 4 for an example.

Device which is configured to perform the methods for identifying a device can also include: input unit 43 and output unit 44.

Processor 41, memory 42, input unit 43 and output unit 44 can be connected by BUS or other methods, and BUS connecting is showed in FIG. 4 for an example.

Memory 42 can be used for storing non-transitory software program, non-transitory computer executable program and modules as a non-transitory computer-readable storage medium, such as corresponding program instructions/modules for the methods for identifying a device mentioned by embodiments of the present disclosure (such as shown in FIG. 2, obtaining unit 21 and determination unit 22). Processor 41 performs kinds of functions and identifying a device of the electronic device by executing non-transitory software program, instructions and modules which are stored in memory 42, thereby realizes the methods for identifying a device mentioned by embodiments of the present disclosure.

Memory 42 can include program storage area and data storage area, thereby the operating system and applications required by at least one function can be stored in program storage area and data created by using the device for identifying a device can be stored in data storage area. Furthermore, memory 42 can include high speed Random-access memory (RAM) or non-volatile memory such as magnetic disk storage device, flash memory device or other non-volatile solid state storage devices. In some embodiments, memory 42 can include long-distance setup memories relative to processor 41, which can communicate with the device for identifying a device by networks. The examples of said networks are including but not limited to Internet, Intranet, LAN, mobile Internet and their combinations.

Input unit 43 can be used to receive inputted number, character information and key signals causing user configures and function controls of the device for identifying a device. Output unit 44 can include a display screen or a display device.

The said module or modules are stored in memory 42 and perform the methods for identifying a device when executed by one or more processors 41.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for identifying a device, applied to a terminal, comprising:
obtaining a target file and a screen size of a device, when starting an application program, wherein the target file is configured to record a wired Media Access Control (MAC) address of the device; and
determining a device type of the device according to the target file and the screen size.

2. The method according to claim 1, wherein the determining of the device type of the device according to the target file and the screen size, comprises:
determining that the device is a set top box, if the target file comprises the wired MAC address and the screen size is zero;
determining that the device is a smart TV, if the target file comprises the wired MAC address and the screen size meets a first size range;
determining that the device is a mobile phone, if the target file does not comprise the wired MAC address and the screen size meets a second size range; and
determining that the device is a tablet computer, if the target file does not comprise the wired MAC address and the screen size meets a third size range.

3. The method according to claim 1, wherein the obtaining of the target file and the screen size of the device comprises:
obtaining the target file along a preset path, and obtaining the screen size by a particular interface.

4. The method according to claim 1, wherein after the device type of the device is determined, the method further comprises:
performing processes on the device according to a preset process scheme corresponding to the device type.

5. The method according to claim 4, wherein the performing of the processes on the device according to the preset process scheme corresponding to the device type, comprises:
sending the device type to an application server; and
receiving heartbeat packets which are sent by the application server at a frequency corresponding to the device type.

6. The method according to claim 4, wherein the device is a device which supports the Android system.

7. A non-transitory computer-readable storage medium storing executable instructions, wherein the executable instructions are configured to:
obtain a target file and a screen size of a device, when starting an application program, wherein the target file is configured to record a wired Media Access Control (MAC) address of the device; and
determine a device type of the device according to the target file and the screen size.

8. The non-transitory computer-readable storage medium according to claim 7, wherein that determine the device type of the device according to the target file and the screen size, comprises:
determine that the device is a set top box, if the target file comprises the wired MAC address and the screen size is zero;
determine that the device is a smart TV, if the target file comprises the wired MAC address and the screen size meets a first size range;
determine that the device is a mobile phone, if the target file does not comprise the wired MAC address and the screen size meets a second size range; and
determine that the device is a tablet computer, if the target file does not comprise the wired MAC address and the screen size meets a third size range.

9. The non-transitory computer-readable storage medium according to claim 7, wherein that obtain the target file and the screen size of the device comprises:
obtain the target file along a preset path, and obtain the screen size by a particular interface.

10. The non-transitory computer-readable storage medium according to claim 7, wherein after the device type of the device is determined, the executable instructions are further configured to:
perform processes on the device according to a preset process scheme corresponding to the device type.

11. The non-transitory computer-readable storage medium according to claim 10, wherein that perform the processes on the device according to the preset process scheme corresponding to the device type, comprises:
send the device type to an application server; and
receive heartbeat packets which are sent by the application server at a frequency corresponding to the device type.

12. The non-transitory computer-readable storage medium according to claim 10, wherein the device is a device which supports the Android system.

13. An electronic device, comprising:
at least one processor; and
a memory communicably connected with the at least one processor for storing instructions executable by the at least one processor, wherein execution of the instructions by the at least one processor causes the at least one processor to:
obtain a target file and a screen size of a device, when starting an application program, wherein the target file is configured to record a wired Media Access Control (MAC) address of the device; and
determine a device type of the device according to the target file and the screen size.

14. The electronic device according to claim 13, wherein that determine the device type of the device according to the target file and the screen size, comprises:
determine that the device is a set top box, if the target file comprises the wired MAC address and the screen size is zero;
determine that the device is a smart TV, if the target file comprises the wired MAC address and the screen size meets a first size range;
determine that the device is a mobile phone, if the target file does not comprise the wired MAC address and the screen size meets a second size range; and
determine that the device is a tablet computer, if the target file does not comprise the wired MAC address and the screen size meets a third size range.

15. The electronic device according to claim 13, wherein that obtain the target file and the screen size of the device comprises:
obtain the target file along a preset path, and obtain the screen size by a particular interface.

16. The electronic device according to claim 13, wherein after the device type of the device is determined, the instructions are executed to cause the at least one processor to:
perform processes on the device according to a preset process scheme corresponding to the device type.

17. The electronic device according to claim 16, wherein that perform the processes on the device according to the preset process scheme corresponding to the device type, comprises:
send the device type to an application server; and
receive heartbeat packets which are sent by the application server at a frequency corresponding to the device type.

18. The electronic device according to claim 16, wherein the device is a device which supports the Android system.
